(19) United States
(12) Patent Application Publication
(10) Pub. No.: US 2024/0066806 A1
(43) Pub. Date: Feb. 29, 2024

(54) 3D-MODELING SYSTEM AND METHOD FOR MANUFACTURING 3D-MOLDED OBJECT

(71) Applicant: SEIKO EPSON CORPORATION, Tokyo (JP)

(72) Inventors: Tatsuya TERAMOTO, SHIOJIRI-SHI (JP); Kazuhide NAKAMURA, ASAHI-MURA (JP); Atsushi MAJIMA, ASAHI-MURA (JP)

(21) Appl. No.: 18/456,398

(22) Filed: Aug. 25, 2023

(30) Foreign Application Priority Data
Aug. 26, 2022 (JP) 2022-135133

(51) Int. Cl. B29C 64/393; B29C 64/209; B29C 64/245; B29C 64/35; B33Y 30/00; B33Y 50/02

(52) U.S. Cl. CPC B29C 64/393; B29C 64/209; B29C 64/245; B29C 64/35; B33Y 30/00; B33Y 50/02

(57) ABSTRACT

A 3D-modeling system includes a first discharge section, a second discharge section, a stage, a heating section, and a control section, wherein the control section performs a modeling process molding a first molded object and a second molded object on a modeling surface by controlling the first and second discharge sections to discharge modeling materials having different plasticization temperatures from each other from the first and second discharge sections and a heating process by controlling the heating section configured to heat the molding materials discharged from the first and second discharge sections at different temperatures from each other, and the modeling process is performed such that a period in which the modeling material discharged from the first discharge section is deposited on the modeling surface and a period in which the modeling material discharged from the second discharge section is deposited on the modeling surface overlap each other.

The present application is based on, and claims priority from JP Application Serial Number 2022-135133, filed Aug. 26, 2022, the disclosure of which is hereby incorporated by reference herein in its entirety.

### BACKGROUND

### 1. Technical Field

The present disclosure relates to a 3D-modeling system and a method of manufacturing a 3D-molded object.

### 2. Related Art

In the related art, the 3D-modeling system that shapes a 3D-molded object by discharging a plasticized material toward a stage and curing the material is known.

For example, JP-A-2006-192710 describes a modeling device comprising an extrusion nozzle for extruding a molten thermoplastic material heated by a preheater onto a base, wherein the extrusion nozzle is configured to be scannable in accordance with preset shape data, and the molten material is further laminated on the material cured on the base to form a 3D modeling object.

A technique called “Duplicated modeling” is known in which a plurality of extrusion nozzles as described above are mounted and a plurality of molded objects are created simultaneously. In a case where a plurality of molded objects are simultaneously created by discharging materials different from each other, since the plasticization temperatures of the materials are different from each other, the strength of the interface between the base and the discharged material and the warpage of the molded object become problems.

### SUMMARY

An aspect of the 3D-modeling system, according to the present disclosure, includes a first discharge section and a second discharge section each including a plasticization section configured to plasticize a material to generate a modeling material and a nozzle configured to discharge the modeling material, a stage including a modeling surface on which the modeling material is deposited, a heating section configured to heat the modeling material deposited on the stage, a control section configured to control the first discharge section and the second discharge section, wherein the control section performs a modeling process of molding a first molded object and a second molded object on the modeling surface by controlling the first discharge section and the second discharge section to discharge the modeling materials having different plasticization temperatures from each other from the first discharge section and the second discharge section and a heating process of controlling the heating section to heat the molding materials discharged from the first discharge section and the second discharge section at different temperatures from each other, and the modeling process is performed such that a period in which the modeling material discharged from the first discharge section is deposited on the modeling surface and a period in which the modeling material discharged from the second discharge section is deposited on the modeling surface overlap each other.

An aspect of the method for manufacturing the 3D-molded object, according to the present disclosure, includes a molding step of forming the first and second molded objects on the modeling surface of the stage by discharging the modeling materials that have different plasticization temperatures each other from the first and second discharge section that plasticize material to generate modeling materials and that discharge the modeling materials, and a heating step of heating the modeling material discharged from the first discharge section and the modeling material discharged from the second discharge section at different temperatures from each other, wherein the molding step is performed such that a period in which the modeling material discharged from the first discharge section is deposited on the modeling surface and a period in which the modeling material discharged from the second discharge section is deposited on the modeling surface overlap each other.

### BRIEF DESCRIPTION OF THE DRAWINGS

FIG. 1 is a perspective view schematically showing a 3D-modeling system, according to the present embodiment.

FIG. 2 is a cross-sectional view schematically showing the 3D-modeling system, according to the embodiment.

FIG. 3 is a perspective view schematically showing a flat screw of the 3D-modeling system, according to the present embodiment.

FIG. 4 is a plan view schematically showing a barrel of the 3D-modeling system according to the present embodiment.

FIG. 5 is a plan view schematically showing the 3D-modeling system, according to the present embodiment.

FIG. 6 is a plan view schematically showing the 3D-modeling system, according to the present embodiment.

FIG. 7 is a flowchart for explaining the operation of the 3D-modeling system, according to the present embodiment.

FIG. 8 is a cross-sectional view that explains the modeling layers formation in the 3D-modeling system, according to the embodiment.

FIG. 9 is a cross-sectional view schematically illustrating a 3D-modeling system, according to a first modification example of the embodiment.

FIG. 10 is a flowchart for explaining an operation of a 3D-modeling system, according to a first modification of the present embodiment.

FIG. 11 is a cross-sectional view schematically showing a 3D-modeling system, according to a second modified example of the embodiment.

FIG. 12 is a flowchart for explaining an operation of a 3D-modeling system, according to a second modification of the present embodiment.

FIG. 13 is a plan view schematically showing a 3D-modeling system, according to a third modification of the present embodiment.

FIG. 14 is a plan view schematically showing a 3D-modeling system, according to a fourth modification of the present embodiment.

FIG. 15 is a flowchart for explaining an operation of a 3D-modeling system, according to a fourth modification of the present embodiment.

FIG. 16 is a plan view schematically showing a 3D-modeling system, according to a fifth modification of the present embodiment.

### DESCRIPTION OF EMBODIMENTS

Hereinafter, preferred embodiments of the present invention will be described in detail with reference to the drawings. It should be noted that the embodiments described below do not unduly limit the contents of the present invention described in the claims. In addition, all of the configurations described below are not necessarily essential constituent elements of the invention.

### 1. 3D-Modeling System

### 1.1. Overall Configuration

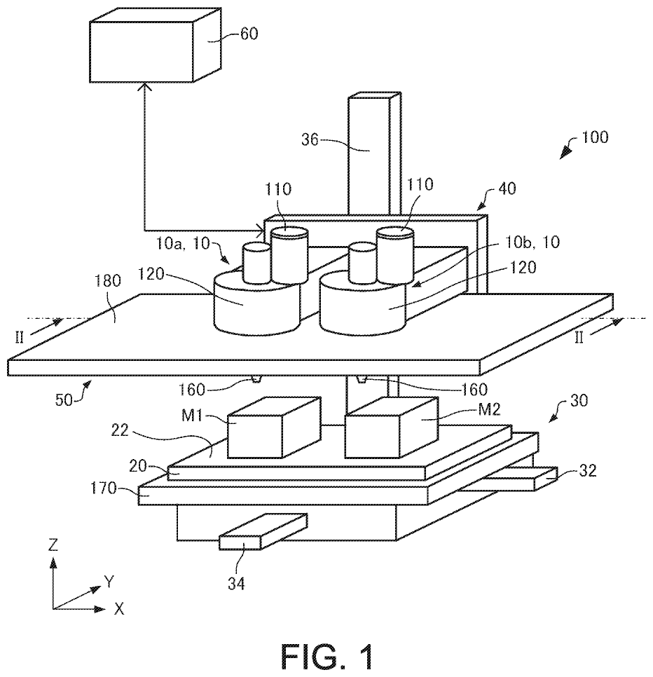

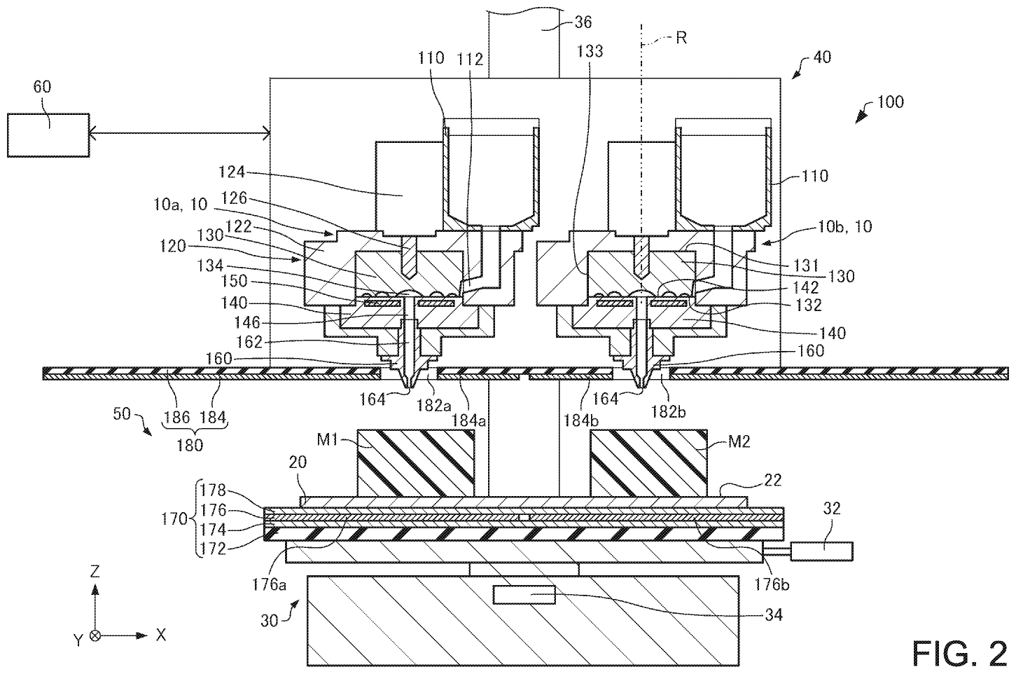

First, a 3D-modeling system according to the present embodiment will be described with reference to the drawings. FIG. 1 is a perspective view schematically illustrating a 3D-modeling system 100 according to the present embodiment. FIG. 2 is a cross-sectional view taken along line II-II of FIG. 1 schematically showing the 3D-modeling system 100 according to the present embodiment.

In FIGS. 1 and 2, an X-axis, a Y-axis, and a Z-axis are shown as three axes orthogonal to each other. The X-axis direction and the Y-axis direction are, for example, horizontal directions. The Z-axis direction is, for example, a vertical direction.

As shown in FIGS. 1 and 2, the 3D-modeling system 100 includes, for example, a discharge section 10, a stage 20, a moving section 30, a support member 40, a heating section 50, and a control section 60.

The 3D-modeling system 100 changes the relative position between the discharge section 10 and the stage 20 by driving the moving section 30 while discharging the plasticized modeling material from the discharge section 10 toward the stage 20. Thus, the 3D-modeling system 100 molds the first molded object M1 and the second molded object M2 as 3D-molded object having desired shapes on the stage 20. The 3D-modeling system 100 is, for example, a 3D-modeling system of a Material EXtrusion system (MEX).

The 3D-modeling system 100 includes a first discharge section 10a and a second discharge section 10b as the discharge section 10. In the illustrated example, the first discharge section 10a and the second discharge section 10b are arranged in the X-axis direction. The configurations of the first discharge section 10a and the second discharge section 10b are, for example, the same. The first discharge section 10a discharges, for example, a modeling material constituting the first molded object M1. The second discharge section 10b discharges, for example, the modeling material constituting the second molded object M2.

The discharge section 10 has, for example, a material supply section 110, a plasticization section 120, and a nozzle 160.

A material pelletized or powdered is put into the material supply section 110. The material supply section 110 supplies a material serving as a raw material to the plasticization section 120. The material supply section 110 is constituted by, for example, a hopper.

As shown in FIG. 2, the material supply section 110 and the plasticization section 120 are coupled to each other by a supply path 112 provided below the material supply section 110. The material put into the material supply section 110 is supplied to the plasticization section 120 via the supply path 112.

The plasticization section 120 includes, for example, a screw case 122, a drive motor 124, a flat screw 130, a barrel 140, and a heater 150. The plasticization section 120 plasticizes the material in a solid state supplied from the material supply section 110, generates a paste-like modeling material having fluidity, and supplies the modeling material to the nozzle 160.

Plasticization is a concept including melting, and refers to change from a solid state to a state having fluidity. Specifically, in the case of a material in which glass transition occurs, plasticization means that the temperature of the material is set to be equal to or higher than the glass transition point. In the case of a material that does not undergo glass transition, plasticization refers to raising the temperature of the material above its melting point.

The screw case 122 is a housing that accommodates the flat screw 130. The barrel 140 is provided on the bottom surface of the screw case 122. The flat screw 130 is housed in a space surrounded by the screw case 122 and the barrel 140.

The drive motor 124 is provided on a top surface of the screw case 122. The drive motor 124 is, for example, a servo motor. A shaft 126 of the drive motor 124 is coupled to a top surface 131 of the flat screw 130. The drive motor 124 is controlled by the control section 60. Although not illustrated, the shaft 126 of the drive motor 124 and the top surface 131 of the flat screw 130 may be coupled to each other via a speed reducer.

The flat screw 130 has a substantially cylindrical shape in which the size in the direction of a rotation axis R is smaller than the size in the direction orthogonal to the direction of the rotation axis R. In the illustrated example, the rotation axis R is parallel to the Z-axis. The torque generated by the drive motor 124 causes the flat screw 130 to rotate about the rotation axis R.

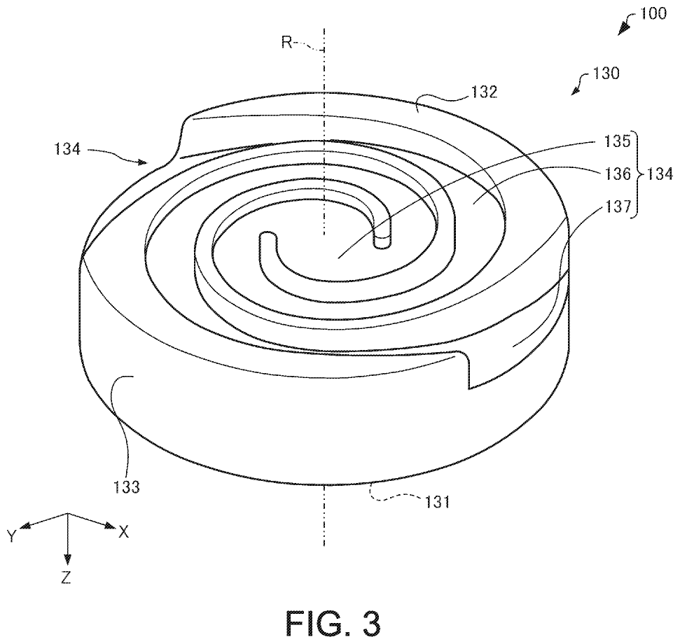

The flat screw 130 has the top surface 131, a groove formed surface 132 on the opposite side from the top surface 131, and a side surface 133 coupling the top surface 131 and the groove formed surface 132. A first groove 134 is formed in the groove formed surface 132. The side surface 133 is, for example, perpendicular to the groove formed surface 132. FIG. 3 is a perspective view schematically showing the flat screw 130. For convenience sake, FIG. 3 shows a state in which the vertical positional relationship is reversed from that shown in FIG. 2.

As shown in FIG. 3, a first groove 134 is formed in the groove formed surface 132 of the flat screw 130. The first groove 134 includes, for example, a central section 135, a coupler 136, and a material introduction section 137. The central section 135 faces a communication hole 146 formed in the barrel 140. The central section 135 communicates with the communication hole 146. The coupler 136 couples the central section 135 and the material introduction section 137. In the illustrated example, the coupler 136 is provided in a spiral shape from the central section 135 toward the outer circumference of the groove formed surface 132. The material introduction section 137 is provided on the outer circumference of the groove formed surface 132. That is, the material introduction section 137 is provided on the side surface 133 of the flat screw 130. The material supplied from the material supply section 110 is introduced from the material introduction section 137 into the first groove 134, passes through the coupler 136 and the central section 135, and is transported to the communication hole 146 formed in the barrel 140. For example, two first grooves 134 are provided.

Note that the number of first grooves 134 is not particularly limited. Although not illustrated, three or more first grooves 134 may be provided, or only one first groove may be provided.

Although not shown, the plasticization section 120 may have an elongate in-line screw having a helical groove on a side surface instead of the flat screw 130. The plasticization section 120 may plasticize the material by rotation of the in-line screw.

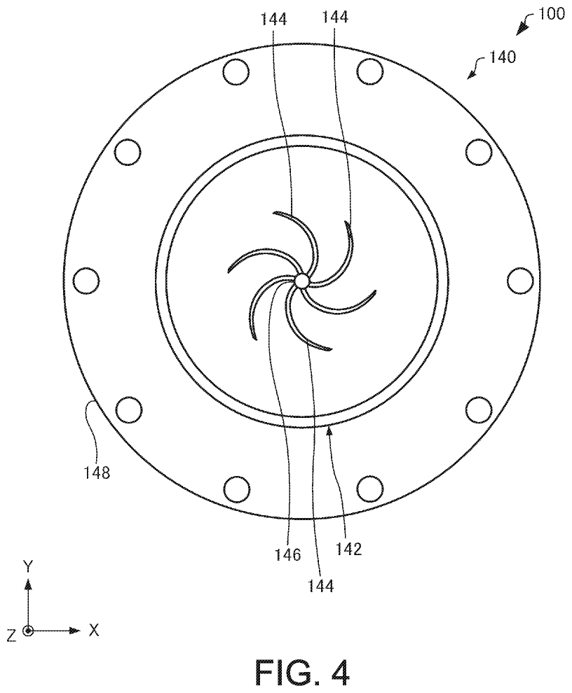

As shown in FIG. 2, the barrel 140 is provided below the flat screw 130. The barrel 140 has a facing surface 142 that faces the groove formed surface 132 of the flat screw 130. The communication hole 146 communicating with the first groove 134 is formed at the center of the facing surface 142. FIG. 4 is a plan view schematically showing the barrel 140.

As shown in FIG. 4, second grooves 144 and the communication hole 146 are formed in the facing surface 142 of the barrel 140. The plurality of second grooves 144 is formed. In the illustrated example, six second grooves 144 are formed, but the number of second grooves 144 is not particularly limited. The plurality of second grooves 144 is formed around the communication hole 146, when viewed from the Z-axis direction. The second grooves 144 have one end coupled to the communication hole 146, and spirally extend from the communication hole 146 toward the outer circumference 148 of the barrel 140. The second grooves 144 have a function of guiding the plasticized modeling material to the communication hole 146.

The shape of the second grooves 144 is not particularly limited, and may be, for example, linear. Further, one end of the second grooves 144 may not be coupled to the communication hole 146. Further, the second grooves 144 may not be formed on the facing surface 142. However, in consideration of efficiently guiding the plasticized material to the communication hole 146, the second groove 144 is preferably formed on the facing surface 142.

As shown in FIG. 2, the heater 150 is provided in the barrel 140. The heater 150 heats the material supplied between the flat screw 130 and the barrel 140. The output of the heater 150 is controlled by the control section 60. The plasticization section 120 generates a plasticized modeling material by heating the material while transporting the material toward the communication hole 146 by the flat screw 130, the barrel 140, and the heater 150. Then, the plasticization section 120 performs the produced modeling material to flow out from the communication hole 146.

The shape of the heater 150 may be a ring shape when viewed from the Z-axis direction. Further, the heater 150 may be located below the barrel 140, for example, rather than inside the barrel 140.

The nozzle 160 is provided below the barrel 140. A nozzle flow path 162 is formed in the nozzle 160. The nozzle flow path 162 communicates with the communication hole 146. A modeling material is supplied to the nozzle flow path 162 from the communication hole 146. The nozzle flow path 162 has a nozzle opening 164. The nozzle opening 164 is opened at the distal end of the nozzle 160. In the illustrated example, the nozzle opening 164 is opened at the end of the nozzle 160 in the −Z axis direction. The nozzle 160 discharges the modeling material from the nozzle opening 164 toward the stage 20.

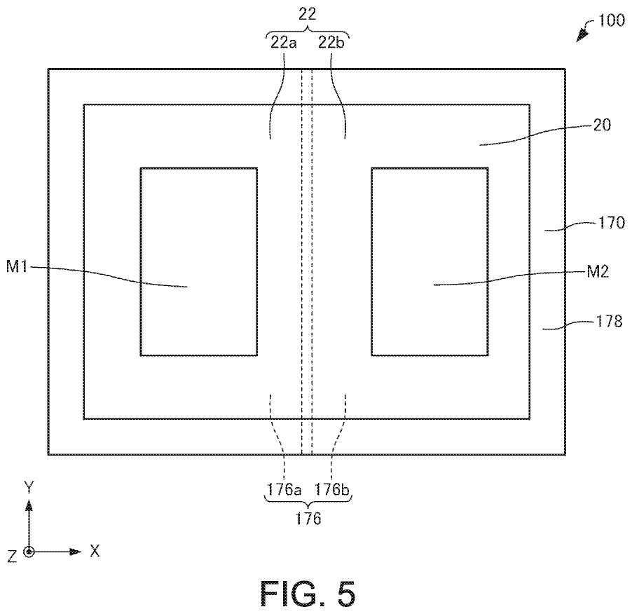

As shown in FIGS. 1 and 2, the stage 20 is provided below the nozzle 160. In the illustrated example, the shape of the stage 20 is a rectangular parallelepiped. The stage 20 has a modeling surface 22 on which the modeling material is deposited. The modeling surface 22 is a region of the top surface of the stage 20. FIG. 5 is a plan view schematically showing the stage 20.

As shown in FIG. 5, the modeling surface 22 of the stage 20 has a first region 22a and a second region 22b when viewed from a direction perpendicular to the modeling surface 22. In the example shown in FIG. 5, the shapes of the first region 22a and the second region 22b are rectangles. In the illustrated example, the direction perpendicular to the modeling surface 22 is the Z-axis direction. As shown in FIG. 2, a first molded object M1 is formed in the first region 22a. The first molded object M1 is, for example, a molded object composed of a modeling material discharged from the first discharge section 10a. The second molded object M2 is formed in the second region 22b. The second molded object M2 is, for example, a molded object composed of a modeling material discharged from the second discharge section 10b.

The material of the stage 20 is, for example, a metal such as aluminum. The stage 20 may be composed of a metal plate and an adhesive sheet provided on the metal plate. In this case, the modeling surface 22 is constituted by the adhesive sheet. The adhesive sheet can improve adhesion between the stage 20 and the modeling material discharged from the discharge section 10.

The moving section 30 supports the stage 20. In the illustrated example, the moving section 30 supports the stage 20 via a first heating section 170 of the heating section 50. The moving section 30 changes the relative position of the nozzle 160 and the stage 20. The first discharge section 10a and the second discharge section 10b are configured to move in conjunction with each other while the distance between the centers of the nozzle openings 164 of the respective nozzles 160 is maintained at a predetermined distance. In the illustrated example, the moving section 30 changes the relative position between the nozzle 160 and the stage 20 in the X-axis direction and the Y-axis direction by moving the stage 20 in the X-axis direction and the Y-axis direction. Further, the moving section 30 changes the relative position of the nozzle 160 and the stage 20 in the Z-axis direction by moving the discharge section 10 in the Z-axis direction.

The moving section 30 has, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the discharge section 10 in the Z-axis direction.

The configuration of the moving section 30 is not particularly limited as long as the moving section 30 can change the relative position between the nozzle 160 and the stage 20. For example, the moving section 30 may be configured to move the stage 20 in the Z-axis direction and move the discharge section 10 in the X-axis direction and the Y-axis direction. Alternatively, the moving section 30 may be configured to move the stage 20 or the discharge section 10 in the X-axis direction, the Y-axis direction, and the Z-axis direction.

The support member 40 is coupled to the third electric actuator 36. The support member 40 supports the discharge section 10. The moving section 30 moves the discharge section 10 in the Z-axis direction by moving the support member 40 in the Z-axis direction by the third electric actuator 36.

The heating section 50 heats the modeling material deposited on the modeling surface 22 of the stage 20. The heating section 50 heats the first molded object M1 and the second molded object M2 created on the modeling surface 22 at different temperatures from each other.

As shown in FIGS. 1 and 2, the heating section 50 has, for example, the first heating section 170 and a second heating section 180.

The first heating section 170 is positioned below the nozzle opening 164. The first heating section 170 is provided below the modeling surface 22. The first heating section 170 is supported by the moving section 30. The first heating section 170 is provided between the moving section 30 and the stage 20. The first heating section 170 moves in conjunction with the stage 20. The first heating section 170 heats the stage 20.

As shown in FIG. 2, the first heating section 170 includes, for example, a heat insulating member 172, a lower plate 174, a heater 176, and an upper plate 178.

The heat insulating member 172 is provided on the moving section 30. The heat insulating member 172 is provided between the moving section 30 and the lower plate 174. The shape of the heat insulating member 172 is, for example, a plate shape. As the heat insulating member 172, for example, ROSLIM Board® is used. The heat insulating member 172 can reduce the heat of the heater 176 transmitted to the lower side of the heat insulating member 172.

The lower plate 174 is provided on the heat insulating member 172. The lower plate 174 is provided between the heat insulating member 172 and the heater 176. The material of the lower plate 174 is, for example, aluminum. The top and lower surfaces of the lower plate 174 are, for example, polished mirror surfaces. Thus, the lower plate 174 can reflect radiant heat from the heater 176 toward the stage 20.

The heater 176 is provided on the lower plate 174. The heater 176 is provided between the lower plate 174 and the upper plate 178. The heater 176 is fixed by being sandwiched between the lower plate 174 and the upper plate 178. The heater 176 is, for example, a plate-shaped heater plate. As the heater 176, for example, a rubber heater is used. The heater 176 heats the stage 20 via the upper plate 178.

As shown in FIGS. 2 and 5, the heater 176 has a first portion 176a and a second portion 176b. In the illustrated example, the first portion 176a and the second portion 176b are separated from each other. Although not shown, the first portion 176a and the second portion 176b may be coupled with each other and provided integrally. The planar shape of the first portion 176a and the second portion 176b is, for example, a rectangle. In the example shown in FIG. 5, the first region 22a of the modeling surface 22 overlaps the first portion 176a when viewed from the Z-axis direction. The first portion 176a heats the first region 22a. When viewed from the Z-axis direction, the second region 22b of the modeling surface 22 overlaps the second portion 176b. The second portion 176b heats the second region 22b.

The heater 176 heats the first region 22a and the second region 22b at different temperatures from each other. The heater 176 heats the first molded object M1 and the second molded object M2 at different temperatures from each other.

The upper plate 178 is provided on the heater 176. The upper plate 178 is provided between the heater 176 and the stage 20. The stage 20 is provided on the upper plate 178. The material of the upper plate 178 is, for example, aluminum. An oxide film, for example, is provided on the top surface and the bottom surface of the upper plate 178. By the oxide film, the radiant heat from the heater 176 can be easily confined, and the stage 20 can be efficiently heated. For example, the stage 20 is detachably attached. The upper plate 178 can prevent the heater 176 from being exposed if the stage 20 is removed.

The second heating section 180 is located above the nozzle opening 164 when the molded objects M1 and M2 are molded. The second heating section 180 is provided above the modeling surface 22. The second heating section 180 is supported by the support member 40. The second heating section 180 moves in conjunction with the discharge section 10. The second heating section 180 has a plate shape. When viewed from the Z-axis direction, the second heating section 180 overlaps the modeling surface 22 of the stage 20.

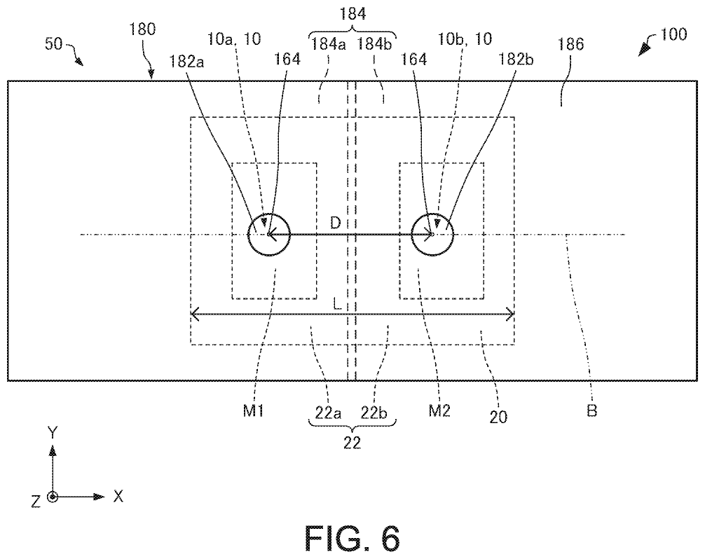

A first through hole 182a and a second through hole 182b are formed in the second heating section 180. The through holes 182a and 182b penetrate the second heating section 180 in the Z-axis direction. At the time of molding, the nozzle 160 of the first discharge section 10a is positioned in the first through hole 182a. The nozzle 160 of the second discharge section 10b is positioned in the second through hole 182b. FIG. 6 is a plan view schematically showing the second heating section 180.

As shown in FIG. 6, the distances D between the centers of the nozzle openings 164 overlapping the first through holes 182a and the centers of the nozzle openings 164 overlapping the second through holes 182b are equal to or less than the lengths obtained by dividing the lengths L of the modeling surface 22, in the direction of the virtual straight line B, by 2. The distance D may be smaller than the length obtained by dividing the length L by 2, or may be equal to the length obtained by dividing the length L by 2. The virtual straight line B is a straight line passing through the nozzle opening 164 of the first discharge section 10a and the nozzle opening 164 of the second discharge section 10b. In the illustrated example, the virtual straight line B passes through the center of the nozzle opening 164 of the first discharge section 10a and the center of the nozzle opening 164 of the second discharge section 10b. The direction of the virtual straight line B is the X-axis direction.

As shown in FIG. 2, the second heating section 180 has, for example, a heater 184 and a heat insulating member 186.

The heater 184 faces the modeling surface 22. The heater 184 is provided between the modeling surface 22 and the heat insulating member 186. The heater 184 is, for example, a plate-shaped heater plate. As the heater 184, for example, a rubber heater is used. The heater 184 heats the modeling surface 22.

As shown in FIGS. 2 and 6, the heater 184 has a first portion 184a and a second portion 184b. In the illustrated example, the first portion 184a and the second portion 184b are separated from each other. Although not shown, the first portion 184a and the second portion 184b may be coupled with each other and provided integrally. The first through hole 182a is formed in the first portion 184a. The second through hole 182b is formed in the second portion 184b.

The planar shape of the first portion 184a and the second portion 184b of the heater 184 is, for example, a rectangle. In the example shown in FIG. 6, the first region 22a of the modeling surface 22 overlaps the first portion 184a when viewed from the Z-axis direction. The temperatures of the first portion 184a and the second portion 184b can be individually controlled by the control section 60. The first portion 184a and the second portion 184b have different temperatures from each other at the time of molding. The first portion 184a heats, for example, the first region 22a. When viewed from the Z-axis direction, the second region 22b of the modeling surface 22 overlaps the second portion 184b. The second portion 184b heats, for example, the second region 22b.

The heater 184, for example, heats the first region 22a and the second region 22b at different temperatures each other. For example, the heater 184 heats the first molded object M1 and the second molded object M2 at different temperatures each other.

Although not shown, the second heating section 180 may have a metal plate under the heater 184. The material of the metal plate is, for example, aluminum.

The heat insulating member 186 is provided on the heater 184. The heat insulating member 186 is coupled to, for example, the support member 40. The heat insulating member 186 can reduce the heat of the heater 184 transmitted to the upper side of the heat insulating member 186.

The control section 60 is configured by, for example, a computer including a processor, a main storage device, and an I/O-interface that performs input and output of signals with the outside. The control section 60 exhibits various functions by, for example, causing the processor to execute programs read into the main storage device. Specifically, the control section 60 controls the discharge sections 10a and 10b, the moving section 30, and the heating section 50. The control section 60 may be configured by a combination of a plurality of circuits instead of the computer.

### 1.2. First Molded Object and Second Molded Object

As shown in FIG. 2, the first molded object M1 is created in the first region 22a of the modeling surface 22. The second molded object M2 is created in the second region 22b of the modeling surface 22. The shapes of the first molded object M1 and the second molded object M2 may be the same or different. The first molded object M1 and the second molded object M2 may have the same size or different sizes.

The plasticization temperature of the modeling material discharged from the first discharge section 10a is different from the plasticization temperature of the modeling material discharged from the second discharge section 10b. The plasticization temperature of the modeling material constituting the first molded object M1 may be different from the plasticization temperature of the modeling material constituting the second molded object M2.

The modeling material discharged from the first discharge section 10a is, for example, Acrylonitrile Butadiene Styrene (ABS) resin. The modeling material discharged from the second discharge section 10b is, for example, PolyStyrene (PS). In the case of a material in which glass transition occurs, the plasticization temperature is a glass transition point. For materials in which no glass transition occurs, the plasticization temperature is the melting point.

### 1.3. Operation

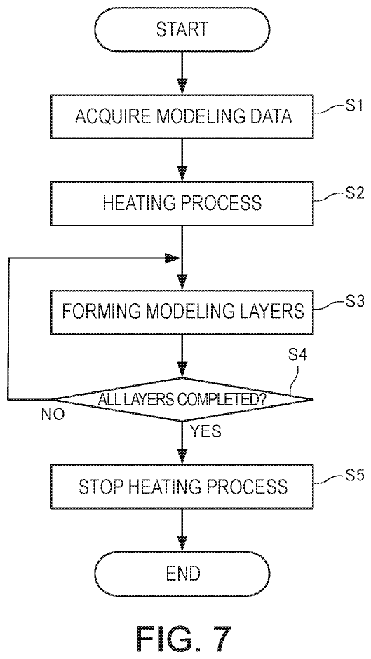

FIG. 7 is a flowchart for explaining the operation of the 3D-modeling system 100. Specifically, FIG. 7 is a flowchart for explaining the processing of the control section 60.

For example, the user operates an operation section (not shown) to output a processing start signal for starting the processing to the control section 60. The operation section includes, for example, a mouse, a keyboard, a touch panel, and the like. Upon receipt of the processing start signal, the control section 60 starts processing.

First, as shown in FIG. 7, in step S1, the control section 60 performs a modeling data acquisition process for acquiring modeling data for creating the first molded object M1 and the second molded object M2.

The modeling data includes, for example, the type of material supplied to the material supply section 110, the moving path of the discharge sections 10a or 10b with respect to the stage 20, the amount of modeling material discharged from the discharge sections 10a or 10b, and the like.

The modeling data is created, for example, by causing slicer software installed in a computer included in the 3D-modeling system 100 to read the shape data. The shape data is data representing a target shape of a 3D-molded object created using 3D-CAD (Computer Aided Design) software, 3D-CG (Computer Graphics) software, or the like. As the shape data, for example, data in a Standard Triangulated Language (STL) format or an Additive Manufacturing File format (AMF), or the like is used. The slicer software divides the target shape of the 3D-molded object into layers each having a predetermined thickness, and creates modeling data for each layer. The modeling data is represented by a G-code, an M-code, or the like. The control section 60 acquires modeling data from a computer coupled to the 3D-modeling system 100 or a recording medium such as a Universal Serial Bus (USB) memory.

Next, as Step S2, the control section 60 controls the heating section 50 to perform heating processing of heating the first and second regions 22a, 22b of the modeling surface 22 at temperatures different from each other.

To be specific, the control section 60 drives the heater 176 of the first heating section 170 and the heater 184 of the second heating section 180, sets the temperature of the first region 22a to a first temperature, and sets the temperature of the second region 22b to a second temperature different from the first temperature. The first temperature may be higher than the second temperature or lower than the second temperature. The control section 60 continues the heating-process until the determination processing of Step S4 (described later) is completed and the stop-heating-process of Step S5 is performed.

Next, as in Step S3, the control section 60 performs the modeling layers formation to create modeling layer on the modeling surface 22 of the stage 20 by discharging the modeling material from the first discharge section 10a and the second discharge section 10b.

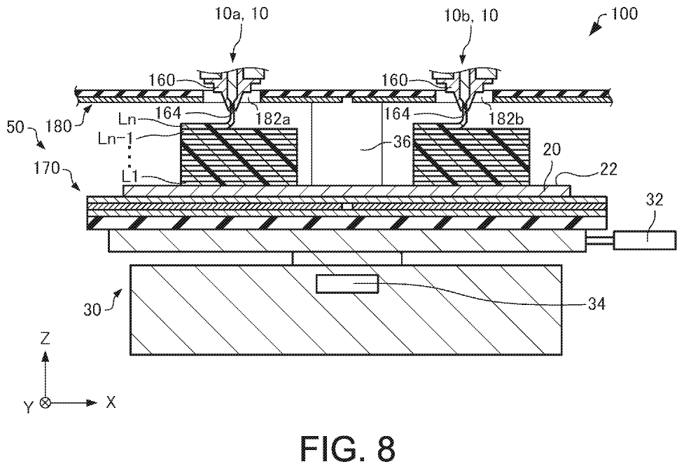

Specifically, the control section 60 drives the drive motor 124 and the heater 150, plasticizes the material supplied between the flat screw 130 and the barrel 140, and generates the modeling material. Then, the control section 60 causes the nozzles 160 of the discharge sections 10a and 10b to discharge the modeling material. For example, the control section 60 continues to cause generating the modeling material until the modeling layers formation is completed. Here, FIG. 8 is a cross-sectional view for explaining the modeling layers formation.

As shown in FIG. 8, the control section 60 controls, based on obtained modeling data, the discharge sections 10a and 10b to discharge the modeling material from the nozzle 160 toward the stage 20 while controlling the moving section 30 to change the relative position between the nozzle 160 and the stage 20.

Specifically, when the modeling layers formation is started, as shown in FIG. 8, the control section 60 controls the moving section 30 to relatively move, for example, the nozzle 160 in the +X axis direction with respect to the stage 20. When the nozzle 160 passes through a predetermined position on the stage 20, the modeling material is discharged from the nozzle 160. Accordingly, the modeling layer L1 is formed. In FIG. 8, “n” is an arbitrary natural number, and layers up to the “n”-th modeling layer Ln are illustrated.

In the process of Step S3, the timing of the discharge from the nozzle 160 of the first discharge section 10a and the timing of the discharge from the nozzle 160 of the second discharge section 10b may be the same. In the process of Step S3, the timing of the discharge from the nozzle 160 of the first discharge section 10a may be different from the timing of the discharge from the nozzle 160 of the second discharge section 10b.

In the process of Step S3, when the first discharge section 10a and the second discharge section 10b discharge at the same timing, in a case where both the modeling material from the first discharge section 10a and the modeling material from the second discharge section 10b are deposited in the first region 22a of the modeling surface 22, the control section 60 may make the timings of the discharge units of the first discharge section 10a and the second discharge section 10b different.

In the process of step S3, in a case where an error of the first discharge section 10a or the second discharge section 10b is detected, the control section 60 may stop molding by the discharge section in which the error is detected and may perform the molding by the discharge section in which the error is not detected. For example, when an error of the second discharge section 10b is detected in the process of Step S3, the control section 60 may stop molding by the second discharge section 10b in which the error is detected and continue molding by the first discharge section 10a in which the error is not detected to create the first molded object M1 without molding the second molded object M2, or may create both the first molded object M1 and the second molded object M2 by the first discharge section 10a in which the error is not detected. The control section 60 may detect an error based on temperature sensors, a force sensor, a material sensor for detecting depletion of a material, or the like, provided in each of the first discharge section 10a and the second discharge section 10b.

Next, as illustrated in FIG. 7, as Step S4, the control section 60 performs a determination process of determining whether or not the formation of all the modeling layers is completed based on the modeling data.

In a case where it is determined that the formation of all the modeling layer is not completed (“NO” in Step S4), the control section 60 returns the process to Step S3. In Step S4, the control section 60 repeats Step S3 and Step S4 until it is determined that the formation of all the modeling layer is completed.

On the other hand, in a case where it is determined that the formation of all the modeling layers is completed (“YES” in Step S4), the control section 60 proceeds to the process of Step S5.

As in Step S3 and Step S4 described above, the control section 60 controls the first discharge section 10a and the second discharge section 10b to discharge the modeling materials having different plasticization temperatures from each other from the first discharge section 10a and the second discharge section 10b, thereby performing the modeling process of molding the first molded object M1 and the second molded object M2 on the modeling surface 22.

The modeling process is performed such that a period in which the modeling material discharged from the first discharge section 10a is deposited on the modeling surface 22 and a period in which the modeling material discharged from the second discharge section 10b is deposited on the modeling surface 22 overlap each other.

By driving the heaters 176, 184 during the processes of Steps S3, S4, the control section 60 heats the modeling material discharged from the first discharge section 10a and the modeling material discharged from the second discharge section 10b at different temperatures from each other. The control section 60 drives the heaters 176, 184 to heat the first molded object M1 and the second molded object M2 at different temperatures from each other.

In Step S5, the control section 60 controls the heating section 50 to stop driving the heaters 176, 184, thereby performing the stop-heating-process for stopping heating. Then, the control section 60 terminates the process.

If the modeling material discharged from the first discharge section 10a and the modeling material discharged from the second discharge section 10b can be heated at different temperatures from each other, the heaters 176, 184 may be started to be driven to start the heating-process after the process of Step S3 is completed or after the process of Step S4 is completed. However, in consideration of the adhesion between the modeling material discharged from the discharge sections 10a and 10b and the modeling surface 22 and the warpage of the molded objects M1 and M2, as shown in FIG. 7, it is preferable to start the heating-process before the process of Step S3 and to perform the stop-heating-process after the process of step S4.

In addition, in the modeling process, as long as the period in which the modeling material discharged from the first discharge section 10a is deposited on the modeling surface 22 partially overlaps the period in which the modeling material discharged from the second discharge section 10b is deposited on the modeling surface 22, the period in which the modeling material discharged from the first discharge section 10a is deposited on the modeling surface 22 and the period in which the modeling material discharged from the second discharge section 10b is deposited on the modeling surface 22 may not completely overlap.

### 1.4. Action and Effect

In the 3D-modeling system 100, the control section 60 controls the first discharge section 10a and the second discharge section 10b to discharge the modeling materials having different plasticization temperatures from each other from the first discharge section 10a and the second discharge section 10b, and performs the modeling process of shaping the first molded object M1 and the second molded object M2 on the modeling surface 22. Further, the control section 60 controls the heating section 50 to perform a heating-process of heating the modeling material discharged from the first discharge section 10a and the modeling material discharged from the second discharge section 10b at different temperatures from each other.

Therefore, in the 3D-modeling system 100, the modeling material discharged from the first discharge section 10a and the modeling material discharged from the second discharge section 10b can be heated in accordance with the plasticization temperature of the modeling material discharged from the first discharge section 10a and the plasticization temperature of the modeling material discharged from the second discharge section 10b. Accordingly, it is possible to increase the strength of the interface between the modeling surface 22 and the modeling material discharged from the discharge sections 10a and 10b. Furthermore, warping of the first molded object M1 and the second molded object M2 can be reduced.

Further, in the 3D-modeling system 100, the modeling process is performed such that a period in which the modeling material discharged from the first discharge section 10a is deposited on the modeling surface 22 and a period in which the modeling material discharged from the second discharge section 10b is deposited on the modeling surface 22 overlap each other. Therefore, in the 3D-modeling system 100, the molding time can be shortened.

In the 3D-modeling system 100, the heating section 50 is positioned below the nozzle opening 164 of the nozzle 160, and includes the first heating section 170 that heats the stage 20. The modeling surface 22 has the first region 22a in which the first molded object M1 is molded and the second region 22b in which the second molded object M2 is molded when viewed from the Z-axis direction. The first heating section 170 heats the first region 22a and the second region 22b at different temperatures from each other. Therefore, in the 3D-modeling system 100, the first heating section 170 can heat the first molded object M1 and the second molded object M2 at different temperatures from each other.

In the 3D-modeling system 100, the heating section 50 includes the plate-shaped second heating section 180 which is positioned above the nozzle opening 164 of the nozzle 160 during molding. The second heating section 180 moves in conjunction with the nozzle 160. The second heating section 180 includes the first portion 184a and the second portion 184b whose temperatures can be individually controlled when viewed from the Z-axis direction. Therefore, in the 3D-modeling system 100, the modeling material discharged from the first discharge section 10a and the modeling material discharged from the second discharge section 10b can be heated by the second heating section 180 at different temperatures from each other.

In the 3D-modeling system 100, when an error of the first discharge section 10a or the second discharge section 10b is detected in the modeling process, the control section 60 stops the molding by the discharge section in which the error is detected and performs the molding by the discharge section in which the error is not detected. Therefore, even when an error is detected in the 3D-modeling system 100, molding can be performed using one discharge section of the first discharge section 10a and the second discharge section 10b.

In the 3D-modeling system 100, the first discharge section 10a and the second discharge section 10b are configured to move in conjunction with each other in a state where the distances D between the centers of the nozzle openings 164 of the nozzles 160 are maintained at predetermined distances. The predetermined distance is equal to or less than the length obtained by dividing the length L of the modeling surface 22 in the direction of the virtual straight line B passing through the center of the nozzle opening 164 of the first discharge section 10a and the center of the nozzle opening 164 of the second discharge section 10b by 2. Therefore, in the 3D-modeling system 100, it is possible to prevent the nozzle opening 164 of the first discharge section 10a and the nozzle opening 164 of the second discharge section 10b from being located outside the stage 20 as viewed in the Z-axis direction during molding. As a result, since the nozzle opening 164 is located outside the stage 20, it is not necessary to perform a process of stopping the discharging from the discharge section 10a, 10b, and control becomes easy.

### 2. Modified Example of 3D-Modeling System

### 2.1. First Modification

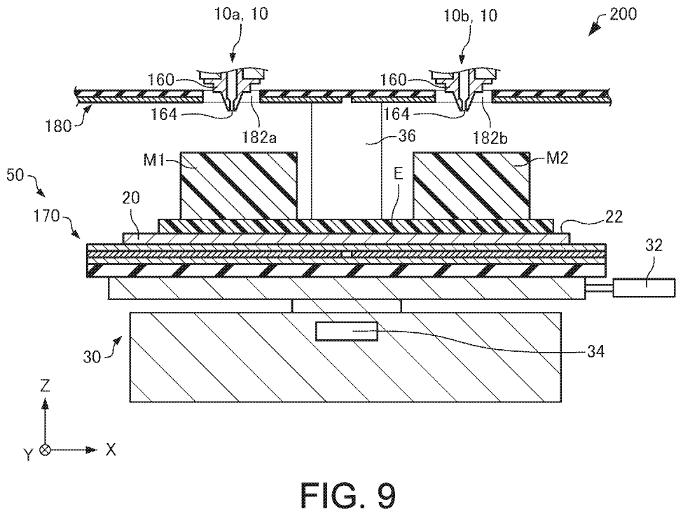

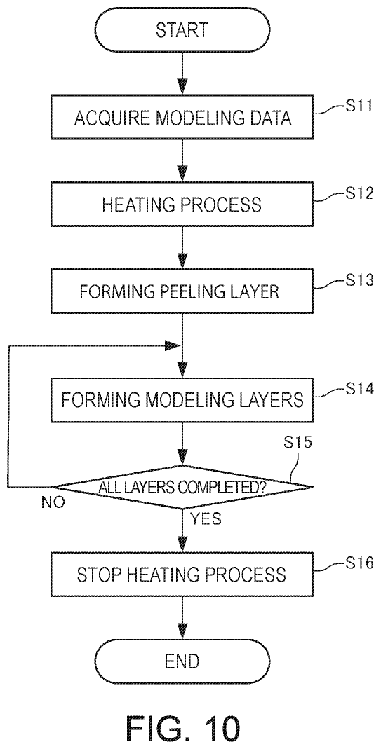

Next, a 3D-modeling system according to a first modified example of the present embodiment will be described with reference to the drawings. FIG. 9 is a cross-sectional view schematically showing a 3D-modeling system 200 according to a first modification of the present embodiment. FIG. 10 is a flowchart for explaining the operation of the 3D-modeling system 200 according to the first modification of the present embodiment.

Hereinafter, in the 3D-modeling system 200 according to the first modification example of the present embodiment, members having the same functions as the constituent members of the 3D-modeling system 100 according to the present embodiment described above are denoted by the same reference numerals, and the detailed description thereof will be omitted. The same applies to 3D-modeling systems according to the second to the sixth modification examples described later.

In the 3D-modeling system 100 described above, as shown in FIG. 2, the first molded object M1 and the second molded object M2 were directly molded on the modeling surface 22 of the stage 20.

On the other hand, in the 3D-modeling system 200, as shown in FIG. 9, the first molded object M1 and the second molded object M2 are molded on the modeling surface 22 through the peeling layer E. The first molded object M1 and the second molded object M2 are molded on the peeling layer.

The plasticization temperature of the modeling material constituting the peeling layer E may have the plasticization temperature which is lower than the plasticization temperature of the forming material constituting the first molded object M1 and the second molded object M2. When the modeling material constituting the first molded object M1 is an ABS resin and the modeling material constituting the second molded object M2 is polystyrene, the modeling material constituting the peeling layer E is, for example, acrylic resin (PMMA).

The plasticization temperature of the modeling material constituting the peeling layer E may be higher than the plasticization temperature of the modeling material constituting the first molded object M1 and the plasticization temperature of the modeling material constituting the second molded object M2. When the modeling material constituting the first molded object M1 is an ABS resin and the modeling material constituting the second molded object M2 is polystyrene, the modeling material constituting the peeling layer E is, for example, polycarbonate (PC).

As shown in FIG. 10, after the heating-process of Step S12 and before the modeling layers formation of Step S14, the control section 60 performs a peeling layer forming process of forming the peeling layer E on the modeling surface 22 by controlling one of the discharge sections of the first discharge section 10a and the second discharge section 10b to discharge the modeling material from the one discharge section as Step S13. The one discharge section may be one of the discharge sections of the first discharge section 10a and the second discharge section 10b for discharging a modeling material with a lower plasticization temperature than the other discharge section. Alternatively, the discharge section may be one of the discharge sections of the first discharge section 10a and the second discharge section 10b for discharging a modeling material with a higher plasticization temperature than the other discharge section. For example, the control section 60 controls the first discharge section 10a to discharge the modeling material from the first discharge section 10a and form the peeling layer E on the modeling surface 22.

Specifically, the control section 60 drives the drive motor 124 and the heater 150, plasticizes the material supplied between the flat screw 130 and the barrel 140, and generates the modeling material. Then, the control section 60 forms the peeling layer E by discharging the modeling material from the first discharge section 10a. The shape of the peeling layer E is based on the modeling data.

Note that the control section 60 may control both the first discharge section 10a and the second discharge section 10b to discharge the modeling material from both the first discharge section 10a and the second discharge section 10b to form the peeling layer E on the modeling surface 22.

The control section 60 molds the first molded object M1 and the second molded object M2 on the peeling layer E in the modeling layers formation of Step S14 and the determination process of Step S15.

The modeling data acquisition process in Step S11, the heating-process in Step S12, the modeling layers formation in Step S14, the determination process in Step S15, and the stop-heating-process in Step S16 shown in FIG. 10 are basically the same as the modeling data acquisition process in Step S1, the heating-process in Step S2, the modeling layers formation in Step S3, the determination process in Step S4, and the stop-heating-process in Step S5 shown in FIG. 7, respectively.

After the control section 60 completes the processing, the user peels off the peeling layer E from the modeling surface 22 of the stage 20 to obtain a structure including the peeling layer E and the molded objects M1, M2. Next, the user peels the peeling layer E from the molded objects M1, M2 to obtain the first molded object M1 and the second molded object M2.

In the 3D-modeling system 200, before the modeling process, the control section 60 performs a peeling layer forming process of forming the peeling layer E on the modeling surface 22 by controlling one of the discharge sections of the first discharge section 10a and the second discharge section 10b to discharge the modeling material from the one discharge section. The control section 60 molds the first molded object M1 and the second molded object M2 on the peeling layer E. The one discharge section may be one of the discharge sections of the first discharge section 10a and the second discharge section 10b for discharging a modeling material with a lower plasticization temperature than the other discharge section. When one discharge section is the discharge section which discharges the modeling material having a low plasticization temperature among the first discharge section 10a and the second discharge section 10b, it is possible to easily peel the peeling layer E from the modeling surface 22. Further, when the single layer of the peeling layer E is peeled off, the two molded objects M1, M2 follow it. Therefore, compared to a case where a dedicated peeling layer is formed for each of the molded objects M1, M2, it is possible to save time and effort of the user.

In the 3D-modeling system 200, the one discharge section may be one of the discharge sections of the first discharge section 10a and the second discharge section 10b that discharges a modeling material having a higher plasticization temperature. If one of the discharge sections is the discharge section of the first discharge section 10a or the second discharge section 10b that discharges the modeling material having a higher plasticization temperature, the peeling layer E can be easily peeled off from the first molded object M1 and the second molded object M2.

In the above description, the example in which the common peeling layer E is formed on the molded objects M1, M2 has been described, but an individual peeling layer may be formed on each of the molded objects M1, M2. To be specific, the control section 60 may form a first peeling layer on the modeling surface 22 by discharging the modeling material from the first discharge section 10a, form a second peeling layer on the modeling surface 22 by discharging the modeling material from the second discharge section 10b, molds the first molded object M1 on the second peeling layer, and molds the second molded object M2 on the first peeling layer. Accordingly, the peeling layer E formed of a material having a plasticization temperature different from that of the molded objects M1, M2 can be molded, and the peeling layer E can be easily peeled off from the molded objects M1, M2.

### 2.2. Second Modification

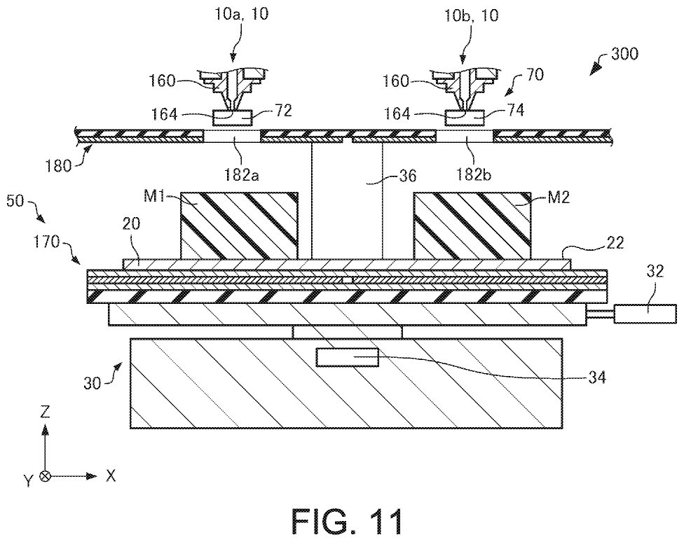

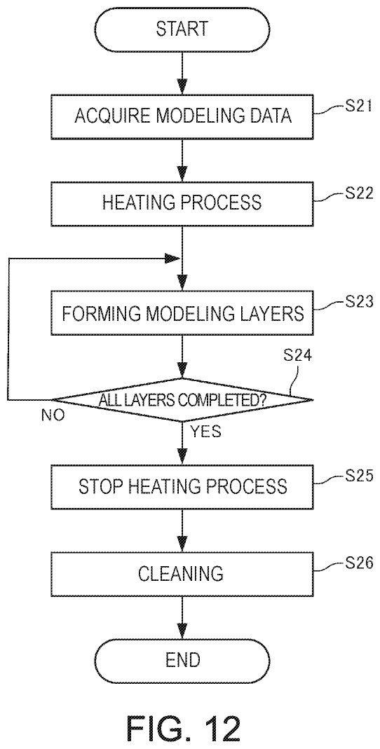

Next, a 3D-modeling system according to a second modification of the present embodiment will be described with reference to the drawings. FIG. 11 is a cross-sectional view schematically showing a 3D-modeling system 300 according to a second modification of the present embodiment. FIG. 12 is a flowchart for explaining the operation of the 3D-modeling system 300 according to the second modification of the present embodiment.

As shown in FIG. 11, the 3D-modeling system 300 is different from the 3D-modeling system 100 described above in that it includes a cleaning mechanism 70.

The cleaning mechanism 70 cleans the nozzle 160. The cleaning mechanism 70 has, for example, a first cleaning section 72 and a second cleaning section 74. The first cleaning section 72 cleans the nozzle 160 of the first discharge section 10a. The second cleaning section 74 cleans the nozzles 160 of the second discharge section 10b. Specifically, the cleaning sections 72, 74 eliminate clogging of the nozzle opening 164 of the nozzle 160 with the modeling material. The cleaning sections 72, 74 are configured to include, for example, a brush in contact with the nozzle 160, and a containing section for containing the modeling material removed by the brush.

The first cleaning section 72 and the second cleaning section 74 are movable in the Y-axis direction, for example, by a cleaner moving section (not shown). When the nozzle 160 is cleaned, the cleaning sections 72, 74 are moved by the cleaner moving sections to positions overlapping the nozzle opening 164 as viewed from the Z-axis direction. The cleaner moving section is configured to include, for example, a rail, a motor, and the like. The cleaner moving section is controlled by the control section 60.

As shown in FIG. 12, for example, after performing the stop-heating-process of Step S25, the control section 60 controls the cleaning mechanism 70 to perform a cleaning process of cleaning the nozzle 160 of the first discharge section 10a and the nozzle 160 of the second discharge section 10b as Step S26.

To be specific, the control section 60 controls the moving section 30 to move the discharge sections 10a, 10b upward with respect to the second heating section 180 in a case where a predetermined time elapses from the start of the modeling layers formation of Step S23. Thus, as shown in FIG. 11, the nozzle 160 is positioned above the through holes 182a and 182b. Next, the control section 60 controls the cleaner moving section of the cleaning mechanism 70 to move the first cleaning section 72 to a position overlapping the nozzle opening 164 of the first discharge section 10a and move the second cleaning section 74 to a position overlapping the nozzle opening 164 of the second discharge section 10b as viewed from the Z-axis direction. As a result, the first cleaning section 72 and the nozzle 160 of the first discharge section 10a come into contact with each other, and the second cleaning section 74 and the nozzle 160 of the second discharge section 10b come into contact with each other, so that the nozzle 160 is cleaned.

The predetermined time in the process of Step S26 is determined, for example, on the basis of the timing of cleaning in the discharge section that discharges the modeling material having a low plasticization temperature among the first discharge section 10a and the second discharge section 10b. For example, in a case where the modeling material of which the plasticization temperature is lower in the first discharge section 10a than in the second discharge section 10b is discharged, the predetermined time in the process of Step S26 is determined based on the timing of the cleaning in the first discharge section 10a. The information on the predetermined time is included in the modeling data. In general, a modeling material having a low plasticization temperature is easily carbonized, and the nozzle 160 is easily contaminated.

The modeling data acquisition processing in Step S21, the heating-process in Step S22, the modeling layers formation in Step S23, the determination process in Step S24, and the stop-heating-process in Step S25 shown in FIG. 12 are basically the same as the modeling data acquisition process in Step S1, the heating-process in Step S2, the modeling layers formation in Step S3, the determination process in Step S4, and the stop-heating-process in Step S5 shown in FIG. 7, respectively.

In the 3D-modeling system 300, when a predetermined time has elapsed from the start of the modeling process, the control section 60 controls the cleaning mechanism 70 to perform a cleaning process of cleaning the nozzle 160 of the first discharge section 10a and the nozzle 160 of the second discharge section 10b. The predetermined time is determined on the basis of the timing of the cleaning in the ejection unit that ejects the modeling material having a low plasticization temperature among the first discharge section 10a and the second discharge section 10b. Therefore, in the 3D-modeling system 300, it is possible to simultaneously perform the cleaning of the discharge section having a small number of times of cleaning in accordance with the cleaning of the discharge section having a large number of times of cleaning among the first discharge section 10a and the second discharge section 10b. As a result, it is not necessary to perform cleaning of only the discharge section for which the number of times of cleaning is small.

### 2.3. Third Modified Example

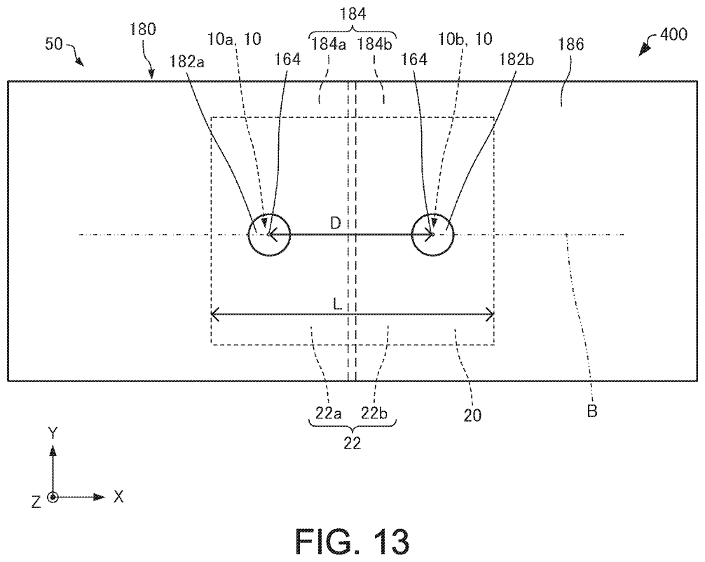

Next, a 3D-modeling system according to a third modification of the present embodiment will be described with reference to the drawings. FIG. 13 is a plan view schematically showing a 3D-modeling system 400 according to a third modification of the present embodiment. For convenience, members other than the stage 20 and the second heating section 180 are not shown in FIG. 13.

In the above-described 3D-modeling system 100, as shown in FIG. 6, the distances D between the nozzle openings 164 of the first discharge section 10a and the nozzle openings 164 of the second discharge section 10b when viewed from the Z-axis direction is equal to or less than the lengths obtained by dividing the lengths L of the modeling surface 22 in the direction of the virtual straight lines B by two. On the other hand, in the 3D-modeling system 400, as shown in FIG. 13, the distance D is equal to or larger than a length obtained by dividing the length L of the modeling surface 22 in the direction of the virtual straight line B by 2 when viewed from the Z-axis direction. Therefore, in the 3D-modeling system 400, it is possible to prevent the nozzle opening 164 of the first discharge section 10a from overlapping the second region 22b of the modeling surface 22 when, viewed from the Z-axis direction, during molding. Accordingly, for example, it is not necessary to perform a process of stopping the discharge from the first discharge section 10a when the nozzle opening 164 of the first discharge section 10a overlaps the second region 22b, and thus the control is facilitated. Further, the nozzle opening 164 of the second discharge section 10b can be prevented from overlapping the first region 22a of the modeling surface 22 when, viewed from the Z-axis direction, during molding.

### 2.4. Fourth Modification

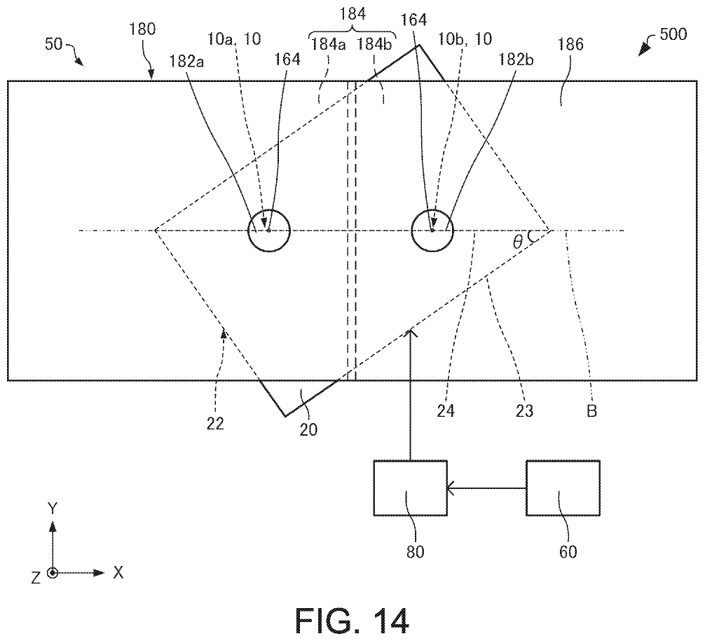

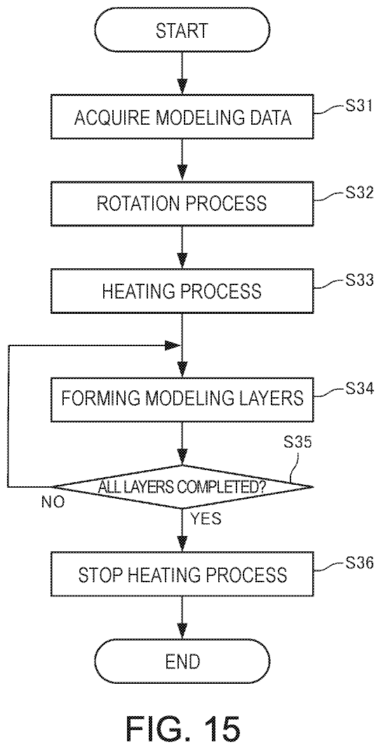

Next, a 3D-modeling system according to a fourth modification of the present embodiment will be described with reference to the drawings. FIG. 14 is a plan view schematically showing a 3D-modeling system 500 according to a fourth modification of the present embodiment. FIG. 15 is a flowchart for explaining the operation of the 3D-modeling system 500 according to the fourth modification of the present embodiment. For convenience, members other than the stage 20, the control section 60, a rotation mechanism 80, and the second heating section 180 are not shown in FIG. 14.

As shown in FIG. 14, the 3D-modeling system 500 is different from the 3D-modeling system 100 described above in that it includes the rotation mechanism 80.

The rotation mechanism 80 relatively rotates the stage 20, the first discharge section 10a, and the second discharge section 10b about the Z-axis direction. The rotation mechanism 80 may rotate the stage 20 and the discharge sections 10a, 10b relative to each other by rotating the stage 20. Alternatively, the rotation mechanism 80 may rotate the stage 20 and the discharge sections 10a, 10b relative to each other by rotating the discharge sections 10a, 10b. The rotation mechanism 80 may rotate the discharge sections 10a, 10b by rotating the support member 40. The rotation mechanism 80 includes, for example, a motor. The rotation mechanism 80 is controlled by a control section 60.

In the illustrated example, the rotation mechanism 80 rotates the stage 20 when viewed from the Z-axis direction. The stage 20 rotates, for example, about the center of the stage 20 as a rotation axis. The rotation axis is, for example, parallel to the Z-axis. For example, the virtual straight line B is inclined at an angle θ with respect to the long side 23 of the modeling surface 22. The angle θ is a rotation angle by the rotation mechanism 80. In the illustrated example, the shape of the modeling surface 22 is rectangular. As viewed from the Z-axis direction, one diagonal line 24 of the modeling surface 22 is parallel to the virtual straight line B.

As illustrated in FIG. 15, for example, after performing the modeling data acquisition process in Step S31, the control section 60 performs a rotation process of rotating the stage 20 by controlling the rotation mechanism 80 in Step S32.

To be specific, the control section 60 determines the rotation angle θ by the rotation mechanism 80 based on the data about the shape of the molded objects M1, M2 included in the modeling data. Then, the control section 60 rotates the stage 20 by the angle θ. For example, when shaping the molded objects M1, M2 having large lengths in the predetermined direction as viewed from the Z-axis direction, the stage 20 is rotated such that the lengths in the predetermined direction are parallel to the diagonal line 24 of the modeling surface 22. Accordingly, the risk that the possibility that the molded objects M1, M2 protrude from the stage 20 can be reduced.

The control section 60 may perform the rotation process while performing the modeling layers formation of Step S34. Thus, it is possible to improve the flexibility of the position of the modeling material discharged from the first discharge section 10a on the modeling surface 22 and the position of the modeling material discharged from the second discharge section 10b on the modeling surface 22. The first molded object M1 and the second molded object M2 including the modeling material discharged from the first discharge section 10a and the modeling material discharged from the second discharge section 10b may be molded.

Further, the modeling data acquisition process in Step S31, the heating-process in Step S33, the modeling layers formation in Step S34, the determination process in Step S35, and the stop-heating-process in Step S36 shown in FIG. 15 are basically the same as the modeling data acquisition process in Step S1, the heating-process in Step S2, the modeling layers formation in Step S3, the determination process in Step S4, and the stop-heating-process in Step S5 shown in FIG. 7, respectively.

The 3D-modeling system 500 includes the rotation mechanism 80 that relatively rotates the stage 20, the first discharge section 10a, and the second discharge section 10b about the Z-axis direction. Therefore, in the 3D-modeling system 500, it is possible to improve the flexibility of the position of the modeling material discharged from the first discharge section 10a on the modeling surface 22 and the position of the modeling material discharged from the second discharge section 10b on the modeling surface 22.

In the 3D-modeling system 500, the control section 60 determines the rotation angle θ of the rotation mechanism 80 based on the shapes of the first molded object M1 and the second molded object M2. Therefore, in the 3D-modeling system 500, it is possible to determine the rotation angle θ in accordance with the shapes of the first molded object M1 and the second molded object M2. Thus, for example, the risk that the first molded object M1 and the second molded object M2 protrude from the stage 20 can be reduced.

### 2.5. Fifth Modification

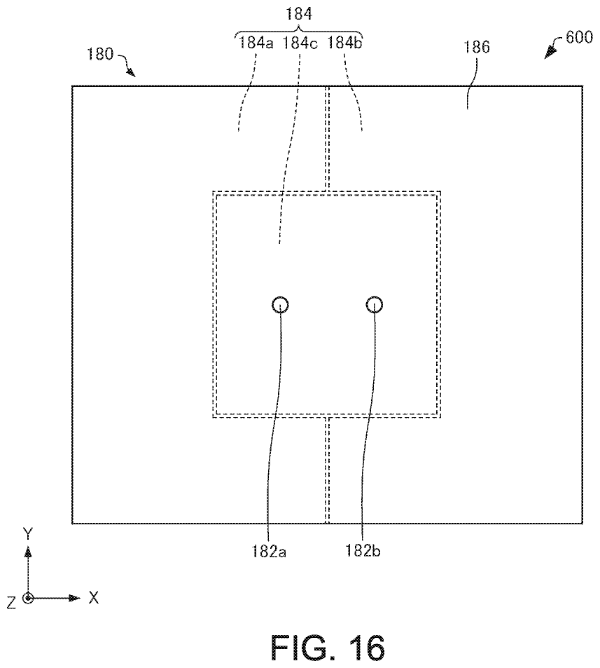

Next, a 3D-modeling system according to a fifth modification of the present embodiment will be described with reference to the drawings. FIG. 16 is a plan view schematically showing a 3D-modeling system 600 according to a fourth modification of the present embodiment. For convenience, members other than the second heating section 180 are not shown in FIG. 16.

In the above-described 3D-modeling system 100, as shown in FIG. 6, the heater 184 of the second heating section 180 has the first portion 184a and the second portion 184b.

On the other hand, as shown in FIG. 16, in the 3D-modeling system 600, the heater 184 has the first portion 184a, the second portion 184b, and a third portion 184c.

When viewed from the Z-axis direction, the first portion 184a and the second portion 184b have a shape surrounding the third portion 184c. In the illustrated example, the third portion 184c is square. The through holes 182a and 182b are formed in the third portion 184c. The first portion 184a, the second portion 184b, and the third portion 184c are different in temperature from each other at the time of molding.

In the 3D-modeling system 600, for example, the temperature of the modeling surface 22 can be controlled more precisely than in the 3D-modeling system 100.

### 2.6. Sixth Modification

Next, a 3D-modeling system according to a sixth modification of the present embodiment will be described.

In the above-described 3D-modeling system 100, the modeling material discharged from the first discharge section 10a is ABS resin, and the modeling material discharged from the second discharge section 10b is polystyrene.

On the other hand, in the 3D-modeling system according to the sixth modification example of the present embodiment, the modeling material discharged from the first discharge section 10a and the modeling material discharged from the second discharge section 10b are not particularly limited as long as the plasticization temperatures are different. The modeling material discharged from the first discharge section 10a and the modeling material discharged from the second discharge section 10b may be materials having different flame retardant grades, may be materials having different colors, or may be a predetermined material and a material obtained by adding glass or carbon fibers to the predetermined material. This will be described more specifically below.

Examples of the modeling material discharged from the discharge sections 10a, 10b include materials containing various materials such as materials having thermoplasticity, metallic materials, and ceramic materials as main materials. Here, the “main material” means a material which is a basic composite of the molded objects M1, M2, and means a material which occupies a content of 50% by weight or more in the molded objects M1, M2. The above-mentioned materials include those obtained by melting these main materials as a single substance and those obtained by melting a part of components contained together with the main materials to form a paste.

As the material having thermoplasticity, for example, a thermoplastic resin can be used. Examples of the thermoplastic resin include generic engineering plastics and super engineering plastics.

Examples of the generic engineering plastic include PolyPropylene (PP); PolyEthylene (PE); PolyOxyMethylene (POM); PolyVinylChloride (PVC); PolyAmide (PA); PolyLacticAcid (PLA); PolyPhenyleneSulfide (PPS); PolyCarbonate (PC); modified polyphenylene ether; polybutylene terephthalate and polyethylene terephthalate.

Examples of the super engineering plastic include PolySUlfone (PSU); PolyEtherSulfone (PES); PolyPhenylene Sulfide (PPS); PolyARylate (PAR); Polylmide (PI); PolyAmidelmide (PAI); PolyEtherlmide (PEI) and PolyEtherEtherKetone (PEEK).

The thermoplastic material may contain a pigment, metal, ceramic, or other additive such as wax, a flame retardant, an antioxidant, or a heat stabilizer. The thermoplastic material is plasticized and converted into a molten state by the rotation of the flat screw 130 and the heating of the heater 150 in the plasticization section 120. The modeling material so produced is also cured by a reduction in temperature after being deposited from the nozzle 160. The thermoplastic material is preferably heated to a temperature equal to or higher than the glass transition point and injected from the nozzle 160 in a completely molted state.

In the plasticization section 120, for example, a metal material may be used as a main material instead of the above-described material having thermoplasticity. In this case, it is desirable that a component which is melted when the modeling material is generated is mixed with the powdered material obtained by pulverizing the metal material, and the mixture is put into the plasticization section 120.

Examples of the metallic material include single metals as Magnesium (Mg), Iron (Fe), Cobalt (Co), Chromium (Cr), Aluminum (Al), Titanium (Ti), Copper (Cu), Nickel (Ni), or alloys containing one or more of these metals, and maraging steel, stainless steel, cobalt chromium molybdenum, titanium alloy, nickel base alloy, aluminum alloy, cobalt alloy, cobalt-chromium alloy.

In the plasticization section 120, a ceramic material can be used as a main material instead of the metal material. Examples of the ceramic material include oxide ceramics such as silicon dioxide, titanium dioxide, aluminum oxide, and zirconium oxide, and non-oxide ceramics such as aluminum nitride.

The powdered material of the metal material or the ceramic material discharged from the discharge sections 10a, 10b may be a powder of a single metal, a powder of an alloy, or a mixed material obtained by mixing a plurality of kinds of powders of the ceramic material. Further, the powdered material of the metal material or the ceramic material may be coated with, for example, the above-described thermoplastic resin or another thermoplastic resin. In this case, the thermoplastic resin may be melted in the plasticization section 120 to exhibit fluidity.

For example, solvents may be added to the powdered material of the metal material or the ceramic material discharged from the discharge sections 10a, 10b. Examples of the solvent include water; a (poly) alkylene glycol monoalkyl ether such as ethylene glycol monomethyl ether, ethylene glycol monoethyl ether, propylene glycol monomethyl ether, propylene glycol monoethyl ether, or the like; an acetic acid esters such as ethyl acetate, n-propyl acetate, iso-propyl acetate, n-isobutyl acetate, and isobutyl acetate, or the like; an aromatic hydrocarbon such as benzene, toluene, and xylene or the like; a ketone such as methyl ethyl ketone, acetone, methyl isobutyl ketone, ethyl-n-butyl ketone, diisopropyl ketone, and acetyl acetone, or the like; an alcohol such as ethanol, propanol and butanol or the like; a tetra alkyl ammonium acetate; a sulfoxide solvent such as dimethyl sulfoxide, diethyl sulfoxide or the like; a pyridine solvent such as pyridine, γ-picoline, 2,6-lutidine, or the like; a tetraalkylammonium acetate (for example, tetrabutylammonium acetate, or the like); or an ionic liquid such as butylcarbitol acetate or the like.

In addition, for example, a binder may be added to the powdered material of the metallic material or the ceramic material discharged from the discharge sections 10a, 10b. Examples of the binder include acrylic resin; epoxy resin; silicone resin; cellulosic resin or other synthetic resin, or PLA, PA, PPS, PEEK and other thermoplastic resin.

The above-described embodiments and modifications are merely examples, and it is not limited thereto. For example, it is possible to appropriately combine the embodiments and the modifications.

The present disclosure includes substantially the same configuration as the configuration described in the embodiment, for example, it includes a configuration having the same function, method, and result, or a configuration having the same objective and effect. In addition, the disclosure includes a configuration in which a non-essential portion of the configuration described in the embodiment is replaced. In addition, the disclosure includes a configuration having the same operation and effect as the configuration described in the embodiment or a configuration capable of achieving the same object. In addition, the disclosure includes a configuration in which a known technology is added to the configuration described in the embodiment.

The following contents are derived from the above-described embodiments and modifications.

An aspect of the 3D-modeling system includes a first discharge section and a second discharge section each including a plasticization section configured to plasticize a material to generate a modeling material and a nozzle configured to discharge the modeling material, a stage including a modeling surface on which the modeling material is deposited, a heating section configured to heat the modeling material deposited on the stage, a control section configured to control the first discharge section and the second discharge section, wherein the control section performs a modeling process of molding a first molded object and a second molded object on the modeling surface by controlling the first discharge section and the second discharge section to discharge the modeling materials having different plasticization temperatures from each other from the first discharge section and the second discharge section and a heating process of controlling the heating section to heat the molding materials discharged from the first discharge section and the second discharge section at different temperatures from each other, and the modeling process is performed such that a period in which the modeling material discharged from the first discharge section is deposited on the modeling surface and a period in which the modeling material discharged from the second discharge section is deposited on the modeling surface overlap each other.

According to the 3D-modeling system, it is possible to increase the strength of the interface between the modeling surface and the modeling material ejected from the first discharge section and the second discharge section, and to reduce the warpage of the first molded object and the second molded object.

In an aspect of the 3D-modeling system, the heating section includes a first heating section that is located below a nozzle opening of the nozzle and that heats the stage the modeling surface includes, as viewed from a direction perpendicular to the modeling surface, a first region in which the first molded object is created and a second region in which the second molded object is created, and wherein the first heating section may heat the first region and the second region at different temperatures from each other.

According to the 3D-modeling system, the first heating section can heat the first molded object and the second molded object at different temperatures from each other.

In an aspect of the 3D-modeling system, the heating section includes a plate-shaped second heating section located above a nozzle opening of the nozzle during molding, wherein the second heating section moves in conjunction with the nozzles, and as viewed from a direction perpendicular to the modeling surface, the second heating section may include a first portion and a second portion whose temperatures are individually controlled.

According to the 3D-modeling system, the modeling material discharged from the first discharge section and the modeling material discharged from the second discharge section can be heated by the second heating section at different temperatures from each other.

In an aspect of the 3D-modeling system, the control section controls to perform a peeling layer forming process to form a peeling layer on the modeling surface by controlling one of the discharge sections of the first discharge section and the second discharge section to discharge the modeling material from the one of the discharge sections before the modeling process, and the control section molds the first molded object and the second molded object on the peeling layer and the one of the discharge sections may be, of the first discharge section and the second discharge section, that which discharges the modeling material having a lower plasticization temperature.

According to the 3D-modeling system, the peeling layer can be easily peeled off from the modeling surface.

In an aspect of the 3D-modeling system, the control section controls to perform a peeling layer forming process to form a peeling layer on the modeling surface by controlling one of the discharge sections of the first discharge section and the second discharge section to discharge the modeling material from the one of the discharge sections before the modeling process, and the control section molds the first molded object and the second molded object on the peeling layer and the one of the discharge sections may be, of the first discharge section and the second discharge section, that which discharges the modeling material having a higher plasticization temperature.

According to the 3D-modeling system, the peeling layer can be easily peeled off from the first molded object and the second molded object.

In an aspect of the 3D-modeling system, the control section performs, before the modeling process, a process of forming a first peeling layer on the modeling surface by discharging the modeling material from the first discharge section and a process of forming a second peeling layer on the modeling surface by discharging the modeling material from the second discharge section and the control section may mold the first molded object on the second peeling layer and molds the second molded object on the first peeling layer.

According to the 3D-modeling system, it is possible to mold the peeling layers molded of a material having a plasticization temperature different from those of the first molded object and the second molded object.

In an aspect of the 3D-modeling system, when an error in the first discharge section or the second discharge section is detected in the modeling process, the control section stops molding by the discharge section in which the error was detected and the control section executes may mold with the discharge section in which an error was not detected.

According to the 3D-modeling system, even when an error is detected, molding can be performed using one of the discharge sections of the first discharge section and the second discharge section.

In an aspect of the 3D-modeling system, further includes a cleaning mechanism configured to clean the nozzle wherein when a predetermined time elapses from start of the modeling process, the control section controls the cleaning mechanism to perform a cleaning process of cleaning the nozzles of the first discharge section and of the second discharge section and the predetermined time may be determined based on a timing of cleaning in the discharge section of the first discharge section and the second discharge section that discharges the modeling material having a lower plasticization temperature.

In the 3D-modeling system, it is possible to simultaneously perform the cleaning of the discharge section having a small number of times of cleaning in accordance with the cleaning of the discharge section having a large number of times of cleaning among the first discharge section and the second discharge section.

In an aspect of the 3D-modeling system, the first discharge section and the second discharge section are configured to move in conjunction with each other in a state where a distance between centers of nozzle openings of the nozzles is maintained at a predetermined distance, and the predetermined distance may be equal to or greater than a length obtained by dividing a length of the modeling surface in a direction of a virtual straight line passing through a center of the nozzle opening of the first discharge section and a center of the nozzle opening of the second discharge section by 2.

According to the 3D-modeling system, it is possible to prevent the nozzle opening of the first discharge section from overlapping the second region of the modeling surface during molding.

In an aspect of the 3D-modeling system, wherein the first discharge section and the second discharge section are configured to move in conjunction with each other in a state where a distance between centers of nozzle openings of the nozzles is maintained at a predetermined distance, and the predetermined distance may be equal to or less than a length obtained by dividing a length of the modeling surface in a direction of a virtual straight line passing through a center of the nozzle opening of the first discharge section and a center of the nozzle opening of the second discharge section by 2.

According to the 3D-modeling system, it is possible to prevent the nozzle opening of the first discharge section and the nozzle opening of the second discharge section from being positioned outside the stage when viewed from the direction perpendicular to the modeling surface during molding.

In an aspect of the 3D-modeling system, further may include a rotation mechanism configured to relatively rotate the stage, the first discharge section, and the second discharge section around a direction perpendicular to the modeling surface.

According to the 3D-modeling system, the degree of freedom regarding the position of the modeling material discharged from the first discharge section on the molding surface and the position of the modeling material discharged from the second discharge section on the modeling surface can be improved.

In an aspect of the 3D-modeling system, the control section may determines rotation angle by the rotation mechanism based on the shapes of the first molded object and the second molded object.

According to the 3D-modeling system, the rotation angle can be determined in accordance with the shapes of the first molded object and the second molded object.

An embodiment about a method of manufacturing a 3D-molded object includes a molding step of forming the first and second molded objects on the modeling surface of the stage by discharging the modeling materials that have different plasticization temperatures each other from the first and second discharge section that plasticize material to generate modeling materials and that discharge the modeling materials, a heating step of heating the modeling material discharged from the first discharge section and the modeling material discharged from the second discharge section at different temperatures from each other, wherein the molding step is performed such that a period in which the modeling material discharged from the first discharge section is deposited on the modeling surface and a period in which the modeling material discharged from the second discharge section is deposited on the modeling surface overlap each other.

According to the manufacturing method of the 3D-molded object, it is possible to increase the strength of the interface between the modeling surface and the modeling material discharged from the first discharge section and the second discharge section, and to reduce the warpage of the first molded object and the second molded object.

What is claimed is:

1. A 3D-modeling system comprising:
a first discharge section and a second discharge section each including
a plasticization section configured to plasticize a material to generate a modeling material and
a nozzle configured to discharge the modeling material;
a stage including a modeling surface on which the modeling material is deposited;
a heating section configured to heat the modeling material deposited on the stage; and
a control section configured to control the first discharge section and the second discharge section, wherein
the control section performs a modeling process of molding a first molded object and a second molded object on the modeling surface by controlling the first discharge section and the second discharge section to discharge the modeling materials having different plasticization temperatures from each other from the first discharge section and the second discharge section and
a heating process of controlling the heating section to heat the molding materials discharged from the first discharge section and the second discharge section at different temperatures from each other, and
the modeling process is performed such that a period in which the modeling material discharged from the first discharge section is deposited on the modeling surface and a period in which the modeling material discharged from the second discharge section is deposited on the modeling surface overlap each other.

2. The 3D-modeling system, according to claim 1, further comprising:
the heating section includes a first heating section that is located below a nozzle opening of the nozzle and that heats the stage wherein
the modeling surface includes, as viewed from a direction perpendicular to the modeling surface,
a first region in which the first molded object is created and
a second region in which the second molded object is created, and
the first heating section heats the first region and the second region at different temperatures from each other.

3. The 3D-modeling system, according to claim 1, further comprising:
the heating section includes a plate-shaped second heating section located above a nozzle opening of the nozzle during molding, wherein
the second heating section moves in conjunction with the nozzles, and
as viewed from a direction perpendicular to the modeling surface, the second heating section includes a first portion and a second portion whose temperatures are individually controlled.

4. The 3D-modeling system, according to claim 1, wherein
the control section controls to perform a peeling layer forming process to form a peeling layer on the modeling surface by controlling one of the discharge sections of the first discharge section and the second discharge section to discharge the modeling material from the one of the discharge sections before the modeling process, and
the control section molds the first molded object and the second molded object on the peeling layer and
the one of the discharge sections is, of the first discharge section and the second discharge section, that which discharges the modeling material having a lower plasticization temperature.

5. The 3D-modeling system, according to claim 1, wherein
the control section controls to perform a peeling layer forming process to form a peeling layer on the modeling surface by controlling one of the discharge sections of the first discharge section and the second discharge section to discharge the modeling material from the one of the discharge sections before the modeling process, and
the control section molds the first molded object and the second molded object on the peeling layer and
the one of the discharge sections is, of the first discharge section and the second discharge section, that which discharges the modeling material having a higher plasticization temperature.

6. The 3D-modeling system, according to claim 1, wherein
the control section performs, before the modeling process, a process of forming a first peeling layer on the modeling surface by discharging the modeling material from the first discharge section and a process of forming a second peeling layer on the modeling surface by discharging the modeling material from the second discharge section and
the control section molds the first molded object on the second peeling layer and molds the second molded object on the first peeling layer.

7. The 3D-modeling system, according to claim 1, wherein
when an error in the first discharge section or the second discharge section is detected in the modeling process, the control section stops molding by the discharge section in which the error was detected and the control section executes molding with the discharge section in which an error was not detected.

8. The 3D-modeling system, according to claim 1, further comprising:
a cleaning mechanism configured to clean the nozzle wherein
when a predetermined time elapses from start of the modeling process, the control section controls the cleaning mechanism to perform a cleaning process of cleaning the nozzles of the first discharge section and of the second discharge section and
the predetermined time is determined based on a timing of cleaning in the discharge section of the first discharge section and the second discharge section that discharges the modeling material having a lower plasticization temperature.

9. The 3D-modeling system, according to claim 1, wherein
the first discharge section and the second discharge section are configured to move in conjunction with each other in a state where a distance between centers of nozzle openings of the nozzles is maintained at a predetermined distance, and
the predetermined distance is equal to or greater than a length obtained by dividing a length of the modeling surface in a direction of a virtual straight line passing through a center of the nozzle opening of the first discharge section and a center of the nozzle opening of the second discharge section by 2.

10. The 3D-modeling system, according to claim 1, wherein
the first discharge section and the second discharge section are configured to move in conjunction with each other in a state where a distance between centers of nozzle openings of the nozzles is maintained at a predetermined distance, and
the predetermined distance is equal to or less than a length obtained by dividing a length of the modeling surface in a direction of a virtual straight line passing through a center of the nozzle opening of the first discharge section and a center of the nozzle opening of the second discharge section by 2.

11. The 3D-modeling system, according to claim 1, further comprising:
a rotation mechanism configured to relatively rotate the stage, the first discharge section, and the second discharge section around a direction perpendicular to the modeling surface.

12. The 3D-modeling system, according to claim 11, wherein
the control section determines a rotation angle by the rotation mechanism based on the shapes of the first molded object and the second molded object.
